(19) United States
(12) Patent Application Publication
(10) Pub. No.: US 2013/0055620 A1
(43) Pub. Date: Mar. 7, 2013

(54) METHOD AND APPARATUS FOR SPEARING FISH

(71) Applicants: Robert Estabrook, Muscatine, IA (US); Joseph Talbot Bixby, Muscatine, IA (US)

(72) Inventors: Robert Estabrook, Muscatine, IA (US); Joseph Talbot Bixby, Muscatine, IA (US)

(21) Appl. No.: 13/225,286

(22) Filed: Sep. 2, 2011

(51) Int. Cl. A01K 81/06; A01K 99/00; A01K 81/04

(52) U.S. Cl. 43/4.5; 43/6

(57) ABSTRACT

A device for spearing a fish may include a shaft having a spearing tip at a first end thereof. A first grip may be attached to a second end of the shaft. A second grip may be slidably engaged with the shaft. An extension spring may be interposed between and may be attached to the first grip and the second grip.

### BACKGROUND OF THE INVENTION

The present invention generally relates to devices and methods that may be employed to spear fish. More particularly, the invention relates to spearing of lionfish.

Lionfish is a species of invasive non-native fish that has invaded the waters of the Caribbean. The lionfish is one of the most venomous fish on the ocean floor. Lionfish have venomous dorsal spines that are used for defense. When threatened, the fish faces its attacker in an upside down posture which brings its spines to bear. Lionfish have no natural enemies that inhabit the waters of the Caribbean and they are destroying reefs across the Caribbean. Various steps are being taken to stop the progression and reproduction of the lionfish and push back the lionfish and its havoc from the Caribbean reefs without damaging the reef or injuring the divers.

Current practices for eradicating lionfish involve spearing the lionfish with large conventional fish spears that may contact and destroy portions of delicate coral reefs in which the lionfish may swim.

As can be seen, there is a need for a method for eradicating lionfish which does not result in damage to coral reefs. Furthermore there is a need for a compact and easy-to-carry device that may perform such eradication by killing lionfish.

### SUMMARY OF THE INVENTION

In one aspect of the present invention, a device for spearing a fish may comprise: a shaft having a spearing tip at a first end thereof; a first grip attached to a second end of the shaft; a second grip slidably engaged with the shaft; and an extension spring interposed between and attached to the first grip and the second grip.

In another aspect of the present invention, a method for spearing a fish may comprise the steps of: providing for applying spring force to a shaft that is attached to a spear tip; providing for placing the spear tip adjacent the fish; and providing for releasing the spring force to allow the spear tip to impale the fish.

These and other features, aspects and advantages of the present invention will become better understood with reference to the following drawings, description and claims.

### BRIEF DESCRIPTION OF THE DRAWINGS

FIGS. 1, 2 and 3 are perspective views of a fish spearing device in accordance with an embodiment of the invention;

FIG. 4 is an exploded view of the device of FIG. 1;

FIG. 5 is a cross-sectional view of the device of FIG. 1 taken along the lines 5-5;

FIG. 6 is a schematic view of the device of FIG. 1 in a potential spearing mode; and

FIG. 7 is a schematic view of the device of FIG. 1 in fish-impaling configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a self-contained powerful and environmentally safe spear device that may kill marine life on reefs. The present invention may provide a spring-driven self-contained spearing device to capture or kill marine life on reefs without disturbing the surrounding environment.

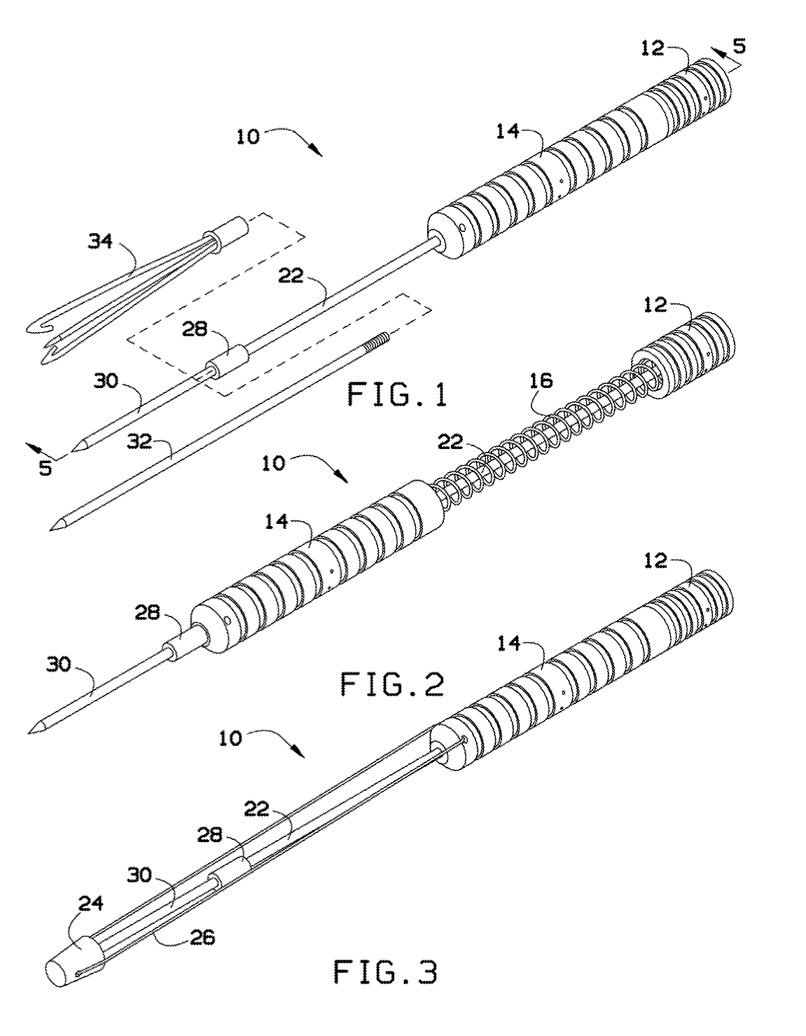

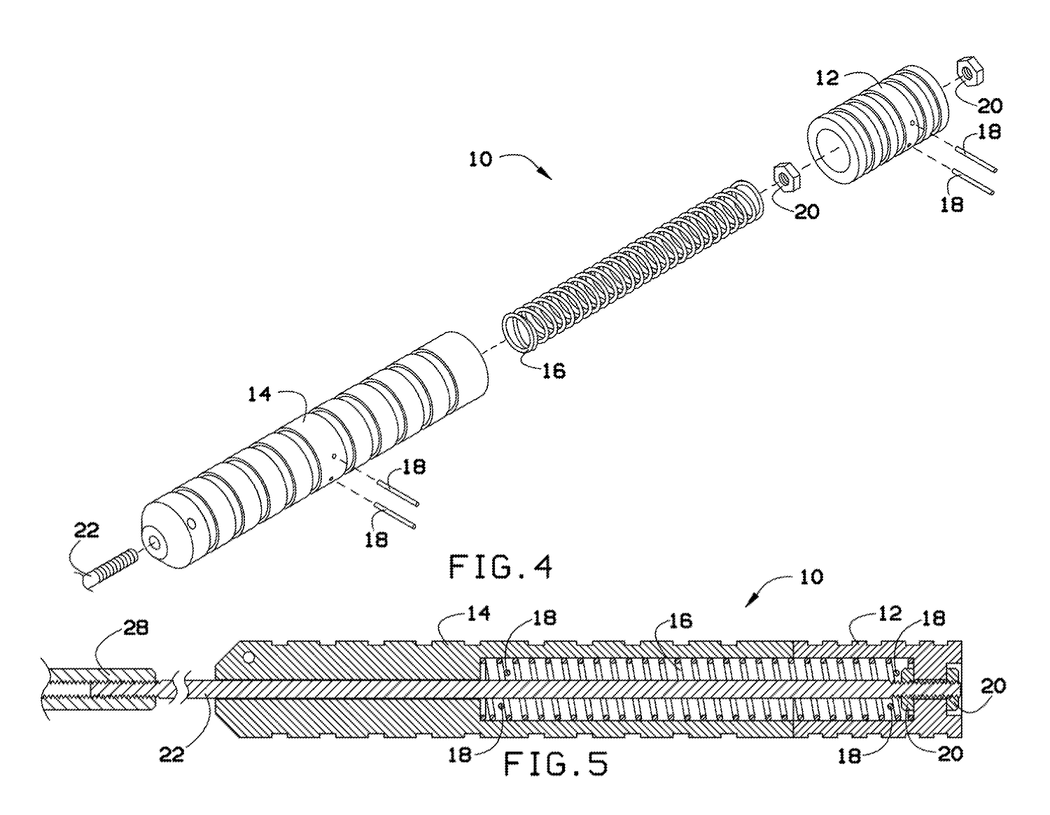

Referring to FIGS. 1 through 5, it may be seen that an exemplary embodiment of a spearing device 10 may comprise a piston grip 12, a cylinder grip 14, an extension spring 16, roll pins 18, nuts 20, a shaft 22 and a spear tip 30. Optionally, the device 10 may be provided with a spear tip safety cover 24 held in place with an elastic band 26. A coupling 28 may be provided so that various types of the spear tips 30 may be attached to the shaft 22.

FIG. 1 illustrates the device 10 in a configuration that may be considered a relaxed mode. FIG. 2 illustrates the device 10 in a configuration that may be considered a potential spearing mode. FIG. 3 illustrates the device 10 in a configuration that may be considered a relaxed, safe mode.

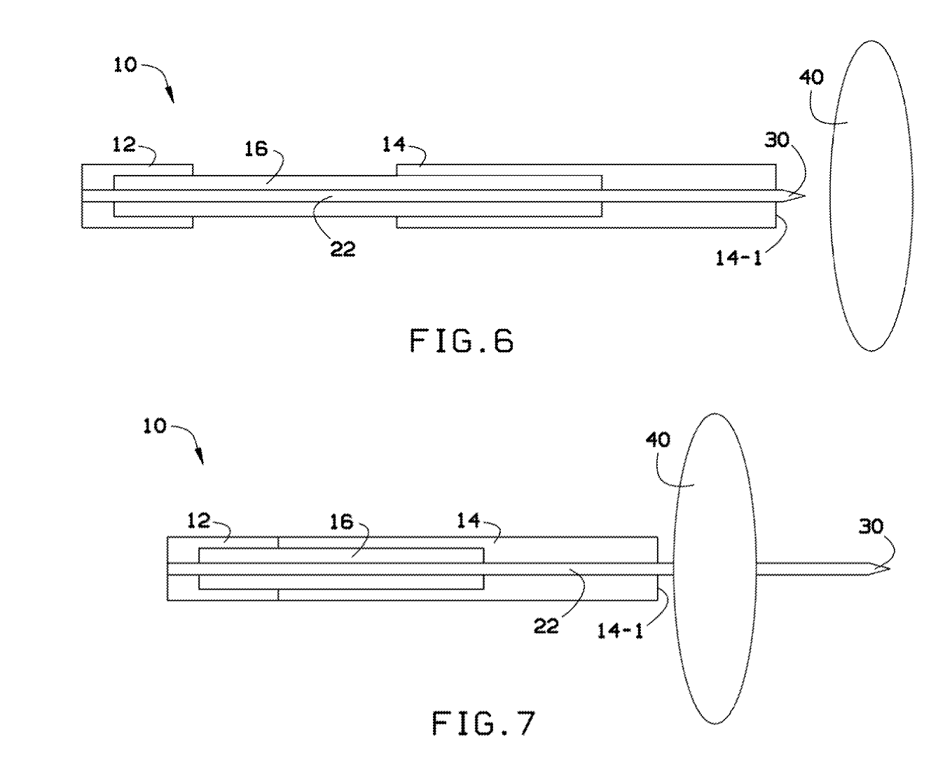

Referring to FIGS. 6 and 7, an exemplary method of using the device 10 to spear a fish such as a lionfish 40 is illustrated. A diver (not shown) may pull the piston grip 12 into a retracted position with one hand while holding the cylinder grip 14 with his or her other hand. This action may extend the spring 16 and draw the spear tip 30 to a position near an outer face 14-1 of the cylinder grip 14. In this configuration the device 10 may be considered to be in the potential spearing mode. The diver may then position the outer face 14-1 and the tip 30 near a lionfish 40. After the tip 30 is positioned near the lionfish 40, the diver may release the piston grip 12 while still holding the cylinder grip 12. The spring 16 may then force the shaft 22 forward and the tip 30 may be driven into and through the lionfish 40.

The device 10 may be uniquely capable of killing lionfish because lionfish, by nature, do not swim away from predators. On the contrary, lionfish depend on their venomous appendages to defend against predators. Consequently, a diver can position the spear tip 30 close to or in actual contact with the lionfish 40 before releasing the piston grip 12. Consequently, the spear tip 30 may need to travel only a short distance before impaling and passing through the lionfish. Tip travel of only about 6 to about 8 inches may be suitable for impaling a lionfish.

It may be seen that with such a short tip-travel distance, the tip 30 may be readily controlled by the diver so that the tip 30 and/or the shaft 22 does not strike and damage delicate coral reef. Moreover, it may be seen that the device 10 may be compact so that it may be attached to D rings of a conventional buoyancy control device and carried continuously by a diver. Thus the device 10 may be available for use at any time that a diver may see a lionfish and wish to kill it.

The device 10 may be adapted so that it may be employed to kill a lionfish that is in location not readily accessible to a diver, e.g., a crevice in a reef. In that case, the diver may remove the tip 30 from the coupling 28 and replace it with an extension tip 32 (see FIG. 1). Even though the extension tip 32 may be long, its tip travel may be the same as that of the tip 30. Furthermore, it is possible to replace the tip 30 with an expandable three prong tip 34 such as that shown in FIG. 1.

It should be understood, of course, that the foregoing relates to exemplary embodiments of the invention and that modifications may be made without departing from the spirit and scope of the invention as set forth in the following claims.

What is claimed is:

1. A device for spearing a fish comprising:
a shaft having a spearing tip at a first end thereof;
a first grip attached to a second end of the shaft;
a second grip slidably engaged with the shaft; and
an extension spring interposed between and attached to the first grip and the second grip.

2. The device of claim 1 wherein the second grip is cylindrical and surrounds the shaft.

3. The device of claim 1 wherein the spearing tip is attached to the shaft with detachable coupling.

4. The device of claim. 4 wherein the spearing tip is a three pronged tip.

5. The device of claim 1 wherein the first grip and the second grip are adjacent to one another when the device is in a relaxed mode and wherein the first grip and the second grip are displaced from one another when the device is in a potential spearing mode.

6. The device of claim 5 wherein the potential spearing mode is extant when the first grip and the second grip are displaced from one another by a distance of about 6 inches to about 8 inches.

7. A method for spearing a fish comprising the steps of:
providing for applying spring force to a shaft that is attached to a spear tip;
providing for placing the spear tip adjacent the fish; and
providing for releasing the spring force to allow the spear tip to impale the fish.

8. The method of claim 7 wherein the step of applying spring force comprises:
holding a grip that surrounds the shaft;
pulling the shaft to extend the spring; and
releasing the shaft so that the extended spring contracts and drives the shaft and the spear tip into the fish.

9. The method of claim 8 wherein the shaft is driven a distance of about 6 inches to about 8 inches.

10. The method of claim 7 wherein the step of pulling the shaft comprises pulling a piston grip that is attached to the shaft.
